(19) United States
(12) Patent Application Publication
(10) Pub. No.: US 2010/0262989 A1
(43) Pub. Date: Oct. 14, 2010

(54) SYSTEM AND METHOD FOR GENERATING INDIVIDUALIZED EXERCISE MOVIES

(75) Inventors: Gerd Lanfermann, Aachen (DE); Kai Eck, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/742,993

(22) PCT Filed: Nov. 18, 2008
(86) PCT No.: PCT/IB08/54830

§ 371 Date: May 14, 2010

(30) Foreign Application Priority Data
Nov. 22, 2007 (EP) 07121291.4

(51) Int. Cl. H04N 7/16; G06Q 50/00; G06F 19/00; G06F 17/30

(52) U.S. Cl. 725/28; 705/3; 707/705; 702/19; 707/E17.009

(57) ABSTRACT

The present invention relates to a system and a method for generating individualized exercise movies. Generalized exercises are modified by factoring in individual limitations and schedules. The generalized exercises are in a data format that allows their representation for example as avatar movements. The individual limitations also correspond to this data format. After combination of the data a motion sequence is generated which depicts the exercise that the patient should perform but wherein the motion sequence does not display any motions that the patient cannot perform. This motion or video sequence is then viewed by the patient and serves as instruction for his exercises.

### FIELD OF THE INVENTION

The present invention relates to a system and a method for generating individualized exercise movies.

### BACKGROUND OF THE INVENTION

Physiotherapists traditionally give exercise homework to patients since the outcome of a physical therapy strongly depends on the intensity and frequency of executing these exercises. The exercises are normally taught to patients during the sessions. A patient may return home with 5 to 6 different exercises which he has to remember. This is a problem for many people, in particular since subtleties like an upright posture may influence the effectiveness of an exercise.

To overcome this problem, therapists may decide to hand out graphical illustrations of the exercises to patients. These illustrations depict an exercise, they may point out what to pay attention to and they may also include some room for notes by the patient, such as the number of repetitions. These illustrations are also available in commercial books. While this is already advantageous when compared to memorizing all exercises, it still is a problem to visualize the dynamics or movements in an exercise.

Training videos, which are readily available in retail stores, overcome this specific problem: they allow a user to get an impression on how a certain movement is to be done. It is a disadvantage that such movies are produced for a large averaged population. Hence these movies fail to address the individual problems and limitations of people. By way of example, a patient may not be able to stretch or bend as far as shown in the movie. As a consequence the patient may lose interest and may eventually quit exercising.

U.S. Pat. No. 6,740,007 B2 is concerned with a method and a system for generating a customized exercise program. A plurality of different measurements (parameters) are input using the computer, and based on these measurements, a computer program creates a customized exercise program for the user. In accordance with embodiments of the invention, the customized exercise program may be specific to conditioning the body or a particular body part of the user, or conditioning the user for a particular sport where both exercise program embodiments may include an optional nutrition plan, or alternatively the nutrition plan may be generated independently. Advantageously, the computer program provides an efficient, customized conditioning (exercise) program for the user that enables a great amount of flexibility and convenience for the user.

However, the customization in this patent is undertaken by converting a received plurality of musculo skeletal measurements into a plurality of ordinal numbers and generating a customized exercise program based on the plurality of ordinal numbers. To these ordinal numbers exercise levels are assigned and the system searches for appropriate exercises.

Despite this effort there still exists the need for a system and a method capable of generating individualized exercise movies where limitations in the mobility of patients are addressed for each patient separately.

### SUMMARY OF THE INVENTION

Accordingly, the present invention is directed towards a system for generating individualized exercise movies,

wherein a movie generator is in communication with an exercise database, an exercise sequencer, a patient database and a movie output unit;

wherein the exercise database comprises generalized representations of exercise motions in a computer-readable form;

wherein the exercise sequencer comprises information about the exercise schedule of individual patients;

wherein the patient database comprises limitations that individual patients have when performing exercise motions, the limitations being in computer-readable form;

wherein the movie generator comprises means for combining generalized exercise motions with limitations that individual patients have when performing the same exercise motions and with the exercise schedule of the individual patients; and

wherein the result of the combination is displayed via the movie output unit.

The present invention is furthermore directed towards a method for generating individualized exercise movies, comprising the steps of:
a) reading limitations that individual patients have when performing exercise motions from a patient database;
b) reading the exercise schedule of individual patients from an exercise scheduler;
c) reading a generalized exercise from an exercise database;
d) combining the generalized exercise with the limitations that individual patients have when performing the generalized exercise and the exercise schedule;
e) calculating representations of the individualized exercise motions that have been obtained from step d); and
f) generating a video sequence of the motions obtained from step e).

In summary, the present invention modifies generalized exercises by factoring in individual limitations and schedules. The generalized exercises are in a data format that allows their representation for example as avatar movements. The individual limitations also correspond to this data format. After combination of the data a motion sequence is generated which depicts the exercise that the patient should perform but wherein the motion sequence does not display any motions that the patient cannot perform. This motion or video sequence is then viewed by the patient and serves as instruction for his exercises.

### BRIEF DESCRIPTION OF THE DRAWINGS

FIG. 1 shows a modular diagram of a system according to the present invention.

FIG. 2 shows a flow chart of a method according to the present invention.

### DETAILED DESCRIPTION OF THE INVENTION

Before the invention is described in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

In the terminology of the present invention, a patient is to be understood in a broad sense. Not only does a patient signify a person needing medical care and undergoing physiotherapeutic rehabilitation, but the term also comprises persons wishing to learn a specific set of movements such as golf swings or the casting of a fly rod.

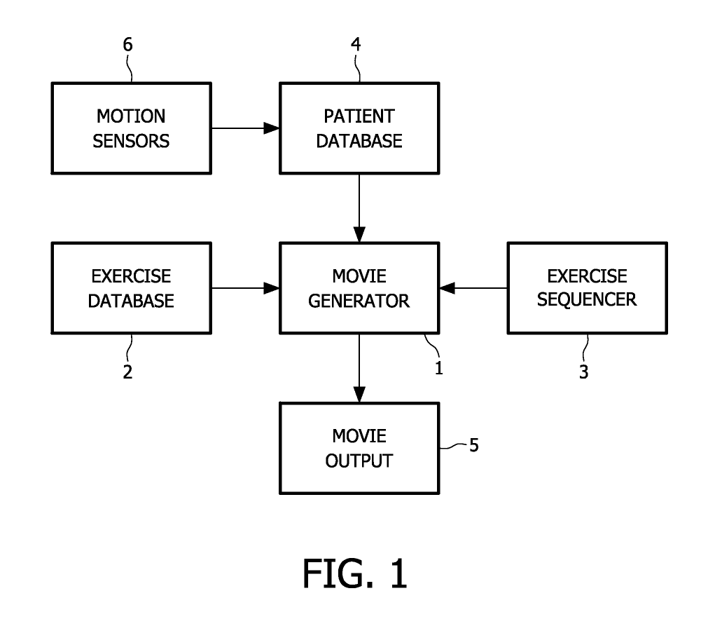

Referring now to FIG. 1, a modular diagram of a system according to the present invention is shown.

The exercise database 2 comprises generalized representations of exercise motions in a computer-readable form. The motions are those that correspond to a person without mobility limitations. Therefore, these exercises can be seen as neutral or idealized exercises. A suitable data format for the exercises is a sequence of angular limb data over time. Individual exercises then comprise an appropriate set of angular limb data sequences. The angular limb data may include, without being restricted to, data relating to cervical or lumbar spinal flexion, spinal extension, spinal rotation, spinal lateral flexion, hip flexion, hip extension, hip adduction, hip abduction, hip rotation, knee flexion, knee extension, ankle plantarflexion, ankle dorsiflexion, foot inversion, foot eversion, shoulder flexion, shoulder extension, shoulder rotation, shoulder abduction, shoulder adduction, elbow flexion, elbow extension, forearm pronation, forearm supination, wrist flexion and wrist extension.

By way of example, the bending of the torso can be measured as a deviation from the vertical over time. The data set {(T_1 t_1), (T_2 t_2), . . . (T_n t_n)} may be used to illustrate the tilt T_1, T_2, etc. of the torso at times t_1, t_2, etc. Other limb data may be added in a hierarchical manner. Thus, the angular data of the shoulder joint may be described relative to the angle of bending of the torso or the angle of the upper arm may be expressed in relative terms from the shoulder.

The exercise sequencer 3 comprises information about the exercise schedule of individual persons. It is used to enter the required number of repetitions, the times per week that a patient should be practicing his exercises, the individual duration of the exercises and further matter related to the execution of exercises over time. Examples for this would be the organizing the exercises by the day of the week or according to the weekly course of a rehabilitation program.

The patient database 4 comprises limitations that individual persons have when performing exercise motions, the limitations being in computer-readable form.

Limitations can refer to restricted mobility of a limb. Preferably, the data structure of the limitations corresponds to the data structure of the exercise database 2. The limitations may be generated when a therapist enters the data manually into the patient database. They may also be generated by using sensors on the patient which then capture the movements of the patient as he is executing the specific exercise.

A third way of generating limitation data would be by an active calibration process involving the participation of the patient. In this, the patient would be equipped with sensors and required to perform specific movements. These movements can be selected in a way that all affected limbs are moved. From these movements the limitations can be derived. For example, a patient would be asked to rotate his arms in a windmill-like fashion as fast as it is comfortable for him. From this motion it would be possible to determine the angular cone angle around the shoulder joint which would then be the maximum angular range for this patient. Additionally, a measure for a time scaling factor can be derived. A fourth way of generating limitation data is by taking into account the muscle tension when an exercise. Muscle tension can be measured using electromyographic (EMG) sensors. Exceeding a pre-determined EMG threshold for a certain muscle or muscle group would indicate that too much strain is placed the patient. Falling below a pre-determined EMG threshold would indicate that the patient is not relaxing a muscle properly even if this is required for the exercise. As a reaction to the EMG data limitations could be placed, for example, on the required angle for lifting a limb or on the time in which a certain position is to be maintained.

The exercise database 2, the exercise sequencer 3 and the patient database 4 are in communication with the movie generator 1. This movie generator comprises means for combining generalized exercise motions with limitations that individual patients have when performing the same exercise motions and with the exercise schedule of the individual patients. The combination of the generalized exercise motions with the individual limitations can be understood as a transformation operation in which the generalized exercise motions are limited or dynamically scaled.

An avatar representation may then be calculated from the transformation result. For the purposes of this invention, the term ‘avatar’ shall denote a computer-generated abstract rendering which represents the posture or motions of a person. In simple cases, the avatar may be a stick figure. In more sophisticated cases, the avatar may be rendered more photo-realistically to reduce possible apprehensions of the viewer against stick figures. The avatar representations are combined to form a movie sequence and the total set of movie sequences is arranged and ordered as prescribed by the exercise schedule.

Alternatively, digital video sequences can be used to form a movie sequence. For this the video sequences would be selected or edited to reflect the individual limitations. It is advantageous use annotated video sequences which describe the motions depicted in the video sequence over time. This serves to indicate the position of a limb during the movement. For example, the annotation may correlate the angle of elbow flexion with the time within the video sequence. A video sequence relating to the elbow flexion would then be cropped as to show only the range of movement that the patient can perform. In another example, the video sequence would be slowed down to reflect that the patient cannot perform a movement as fast as a healthy person. The video sequences may be in a compressed or uncompressed format.

The movie output unit 5 displays the movie to the patient. Examples for such movie output units are computer screens. In case the movie generator 1 stores the movie on a storage medium, then the movie output unit 5 can be an appropriate device for reading the storage medium and playing the movie. This could be a DVD player or a separate computer.

In an advantageous embodiment, the limitations in the patient database are expressed as minimum and maximum angular range of movement around a joint. Both the minimum and the maximum possible positions of limbs around a joint need to be considered because an immobility due to injury will affect the movement in all possible directions. For example an elbow joint which has been kept in a 90° position due to a plaster cast on the upper and lower arm will be restricted in both extension and flexion.

In hinge joints like the elbow or the knee joint one would use two angles to specify the possible range of movement. Other joints which permit a limb to be moved in more than one plane would require the identification of permitted cone angles. An example for the latter type of joint is a ball and socket joint like the shoulder or hip joint.

In a further advantageous embodiment, the limitations in the patient database are expressed as the maximum speed of movement around a joint. This introduces a scaling factor. If the patient is only able to move slowly, the exercise will also be shown slower. If desired, the scaling factor can also lead to a faster showing of the exercise.

In a further advantageous embodiment, the system further comprises motion sensors in communication with the patient database. FIG. 1 shows the connection of motion sensors 6 with patient database 4. Suitable motions sensors can be acceleration sensors, magnetic sensors, gravity sensors or integrated combinations thereof. Highly integrated solid-state motion sensors are commercially available. The sensors are attached to the patient performing the exercises and send their signals to the patient database. There the signals are evaluated and transformed into representations of the patient's movements. An advantage of this assembly is that the progress of the patient can be monitored continuously and so the limitations in the patient database can be kept up to date. For example, the motion sensors report on how far a limb can be moved. If this exceeds the existing limit in the patient database, then this limit is replaced by the new values. By this it is possible to adapt the exercises and to reflect the improvement in the condition of the patient.

In a further advantageous embodiment, the system further comprises physiology sensors in communication with the patient database. Physiology sensors monitor the physical and physiological state of the person. Examples for such sensors include electromyographic (EMG) sensors, cardiac rate sensors, respiratory rate sensors, skin conductivity sensors and blood oxygen sensors. The sensors are attached to the patient performing the exercises and send their signals to the patient database. There the signals are evaluated and transformed into representations of the patient's physiological state. An advantage of this assembly is that the progress of the patient can be monitored continuously and so the limitations in the patient database can be kept up to date. For example, the EMG sensors report on how easy or difficult it is to move a limb if the joint is not affected. If the muscle strain falls, it means that the patient has become stronger. By this it is possible to adapt the exercises and to reflect the improvement in the condition of the patient.

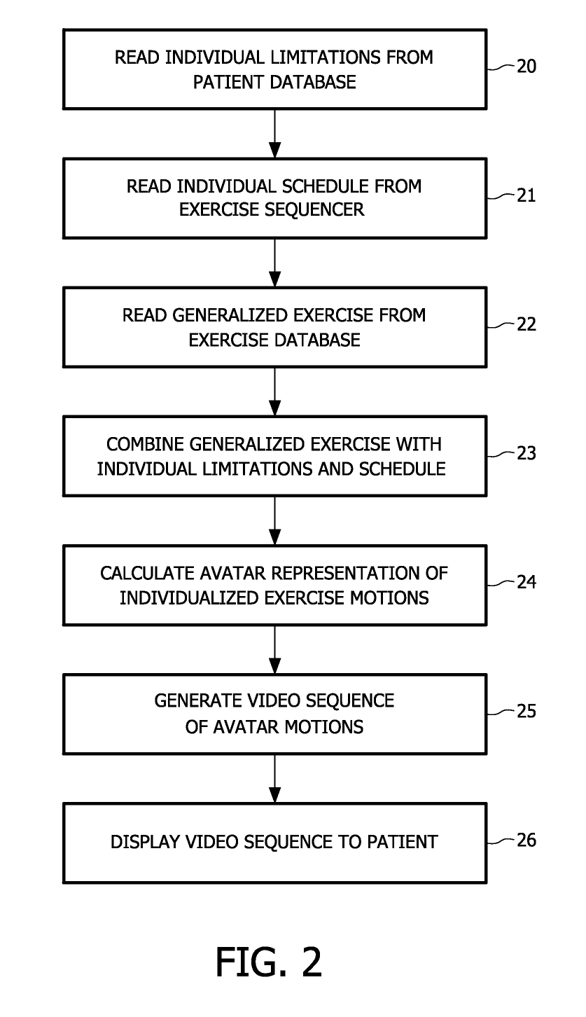

Referring now to FIG. 2, a flow chart of a method according to the present invention is shown. The first step 20 involves reading limitations that individual patients have when performing exercise motions from a patient database 4. This can be read into the memory of movie generator 1. Individual limitations can be expressed in the ability to move certain limbs regarding a minimum and maximum angular range. For example, if the bending of the torso is concerned, the limitation may adopt the form of T_min≧T_i≧T_max. Another limitation may be the possible speed of movement of a limb. Then, a scaling factor f may be introduced to account for this fact.

Step 21 concerns reading the exercise schedule of individual patients from an exercise scheduler 3. For example, the number of repetitions and the duration of an individual exercise is read. The schedule can be read into the memory of movie generator 1.

Step 22 concerns reading a generalized exercise from an exercise database 2. This generalized exercise can also be seen as an exercise template which can be adapted or restricted. This exercise can also be read into the memory of movie generator 1.

Step 23 concerns combining the generalized exercise with the limitations that individual patients have when performing the generalized exercise and the exercise schedule. The result of this combination is an individualized exercise with respect to the possible range of movement of the patient and with respect to the time schedule of the patient. This combination can take place in movie generator 1.

For example, the data set of the generalized exercise relates to the bending of the torso in the form of {(T_1 t_1), (T_2 t_2), . . . (T_n t_n)}, meaning the tilt T_1, T_2, etc. of the torso at times t_1, t_2, etc. An individual limitation is that the bending of the torso is restricted to the range of T_min to T_max. A combination of the data sets results in directions for animating an avatar where any tilt T_i does not fall below T_min or exceed T_max.

Another example is when the individual limitation lies in the dynamics of a movement. Then a scaling factor f may be introduced to modify the data in the generalized exercise. For the bending of the torso, this would correspond to a data set of {(T_1 t_1*f), (T_2 t_2*f), . . . (T_n t_n*f)}. Thus, the time t_n that a certain tilt T_n is adopted has been modified. For a slower movement, the factor f is <1. For a faster movement, the factor f is >1.

Step 24 concerns calculating avatar representations of the individualized exercise motions that have been obtained from step 23. The representations are then further processed in step 25, which concerns generating a video sequence of the avatar motions obtained from step 24. The video sequence is then displayed to the patient in step 26.

Alternatively, instead of calculating avatar representations in step 24 and generating a video sequence of the avatar motions in step 25 representations based on digital video sequences can be selected and/or edited to obtain a representation of individualized exercise motions.

In an advantageous embodiment of the method, step f) further comprises arranging the video sequence in separate chapters, storing the video sequence on a storage medium and granting access to the separate chapters according to pre-determined conditions. By arranging the video sequence the exercise schedule of the patient is taken into account. A complete exercise session can be grouped into one chapter so that the patient does not run danger of omitting any exercises intended for him. The storage medium can, for example, be a compact disc (CD), a digital versatile disc (DVD), a hard disc drive (HDD) located locally on a computer or located remotely on a server. By selectively granting access to separate chapters an overzealous patient is prevented from undertaking exercises that would be too early for him to perform and thus not be beneficial for him. Furthermore, access to previous chapters can also be denied in order to prevent that people for who the exercise has not been designed undertake the exercises once the storage medium is not under control of the patient anymore.

In a further advantageous embodiment of the method, the pre-determined conditions for granting access to the separate chapters of the video sequence are selected from the group comprising access codes and/or the reaching of pre-determined mobility thresholds as measured by motion sensors. Access codes may be given to the patient by the therapist after reviewing the patient's progress and deciding that new exercises can be performed. Alternatively, the patient's movements can be monitored by motion sensors and, according to the progress in mobility made, access can be granted once the actual mobility of the limbs monitored by the sensors reaches a threshold set by the therapist. By this automatization fewer visits to the therapist are necessary.

In a further advantageous embodiment of the method, step f) further comprises transmitting the video sequence to a viewer via a computer network. This can be done in a local area network that may be installed in a hospital or rehabilitation center in order to make effective use of computer resources. Another possibility is to transmit the video sequence via the Internet to a patient's computer at home.

Another aspect of the present invention is a storage medium, comprising a program enabling a computer to carry out the method according to the present invention. The storage medium can, for example, be a compact disc (CD), a digital versatile disc (DVD), a hard disc drive (HDD) located locally on a computer or located remotely on a server.

To provide a comprehensive disclosure without unduly lengthening the specification, the applicant hereby incorporates by reference each of the patents and patent applications referenced above.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A system for generating individualized exercise movies,
wherein a movie generator (1) is in communication with an exercise database (2), an exercise sequencer (3), a patient database (4) and a movie output unit (5);
wherein the exercise database (2) comprises generalized representations of exercise motions in a computer-readable form;
wherein the exercise sequencer (3) comprises information about the exercise schedule of individual patients;
wherein the patient database (4) comprises limitations that individual patients have when performing exercise motions, the limitations being in computer-readable form;
wherein the movie generator (1) comprises means for combining generalized exercise motions with limitations that individual patients have when performing the same exercise motions and with the exercise schedule of the individual patients; and
wherein the result of the combination is displayed via the movie output unit (5).

2. System according to claim 1, wherein the limitations in the patient database (4) are expressed as minimum and maximum angular range of movement around a joint.

3. System according to claim 1, wherein the limitations in the patient database (4) are expressed as the maximum speed of movement around a joint.

4. System according to claim 1, further comprising motion sensors (6) in communication with the patient database (4).

5. System according to claim 1, further comprising physiology sensors in communication with the patient database (4).

6. A method for generating individualized exercise movies, comprising the steps of:
a) reading limitations that individual patients have when performing exercise motions from a patient database (4);
b) reading the exercise schedule of individual patients from an exercise scheduler (3);
c) reading a generalized exercise from an exercise database (2);
d) combining the generalized exercise with the limitations that individual patients have when performing the generalized exercise and the exercise schedule;
e) calculating representations of the individualized exercise motions that have been obtained from step d); and
f) generating a video sequence of the motions obtained from step e).

7. Method according to claim 6, wherein step f) further comprises arranging the video sequence in separate chapters, storing the video sequence on a storage medium and granting access to the separate chapters according to pre-determined conditions.

8. Method according to claim 7, wherein the pre-determined conditions for granting access to the separate chapters of the video sequence are selected from the group comprising access codes and/or the reaching of pre-determined mobility thresholds as measured by motion sensors.

9. Method according to claim 6, wherein step f) further comprises transmitting the video sequence to a viewer via a computer network.

10. Storage medium, comprising a program enabling a computer to carry out the method of claim 6.
